(19) United States
(12) Patent Application Publication
(10) Pub. No.: US 2014/0026854 A1
(43) Pub. Date: Jan. 30, 2014

(54) CARBURETOR SYSTEM FOR A CARBURETOR ENGINE

(71) Applicants: Fredrik Lindström, Huskvarna (SE); Pär Martinsson, Jonkoping (SE); Magnus Ottosson, Norrahammar (SE); Rikard Rydberg, Tenhult (SE)

(72) Inventors: Fredrik Lindström, Huskvarna (SE); Pär Martinsson, Jonkoping (SE); Magnus Ottosson, Norrahammar (SE); Rikard Rydberg, Tenhult (SE)

(73) Assignee: HUSQVARNA AB, Huskvarna (SE)

(21) Appl. No.: 14/110,604

(22) PCT Filed: Apr. 15, 2011
(86) PCT No.: PCT/SE11/50464

§ 371 Date: Oct. 8, 2013

(51) Int. Cl. F02M 1/16

(52) U.S. Cl. CPC F02M 1/16
USPC 123/437

(57) ABSTRACT

A fuel supply system for small two-stroke internal combustion engines for e.g. chain saws, line trimmers and similar hand-held power-tools including a diaphragm carburetor (20) equipped with a purging system (80a, 81a) or priming system (80b, 81b) for facilitating starting of the engine (1). Downstream of the diaphragm (30), the carburetor has a fuel valve (60) with a fuel cavity (73), which when the valve is not closed being connected via a fuel conduit (37) to a fuel nozzle (35, 36) in a main air passage (21) in the carburetor. The purging system or priming system including a fuel line (80a; 80b), which is provided with a manually operated pump (81a; 81b) and is connected between a fuel tank (26) and either the fuel cavity (73) or the fuel conduit (37).

### TECHNICAL FIELD

The present invention relates to a fuel supply system of an internal combustion engine including a carburetor with a main air passage, the carburetor having a fuel pump supplying fuel to a fuel regulator from a fuel tank, said fuel supply system further including a fuel valve for controlling delivery of fuel to a main air passage of a carburetor of an internal combustion engine, the fuel valve including at least one inlet port for receiving fuel from a fuel regulator of the carburetor, at least one fuel outlet port for connecting to at least one nozzle in the air passage leading into the engine, a fuel cavity between the inlet port and the outlet port, and a valve member movable in a manner so as to enable at least two states, a first state permitting flow of fuel from the inlet port through the cavity to the outlet port of the valve, and a second state at least principally blocking such flow.

It also relates to a hand held tool powered by a two stroke crank case scavenged internal combustion engine including said fuel supply system.

It further relates to a fuel valve for controlling delivery of fuel to a main air passage of a carburetor of an internal combustion engine, the fuel valve including at least one inlet port for receiving fuel from a fuel regulator of the carburetor, at least one fuel outlet port for connecting to at least one nozzle in the air passage leading into the engine, a fuel cavity between the inlet port and the outlet port, and a valve member movable in a manner so as to enable at least two states, a first state permitting flow of fuel from the inlet port through the cavity to the outlet port of the valve, and a second state at least principally blocking such flow.

It further relates to a carburetor having an integral fuel valve or a fuel valve that connects to the exterior of the carburetor.

It also relates to a method for facilitating starting of an internal combustion engine including a carburetor with a main air passage, the carburetor having a fuel pump supplying fuel to a fuel regulator from a fuel tank, said fuel supply system further including a fuel valve for controlling delivery of fuel to a main air passage of the carburetor, the fuel valve including at least one inlet port for drawing fuel from a fuel regulator of the carburetor, at least one fuel outlet port for connecting to at least one nozzle in the air passage leading into the engine, a fuel cavity between the inlet port and the outlet port, and a valve member movable in a manner so as to enable at least two states, a first state permitting flow of fuel from the inlet port through the cavity to the outlet port of the valve, and a second state at least principally blocking such flow.

### BACKGROUND ART

Hand held power-tools such as, but not limited to, chain saws and line trimmers, are often powered by small two stroke internal combustion engines that are equipped with diaphragm carburetors. Generally, a diaphragm carburetor has a main air passage where fuel and air is mixed in a correct ratio. An outlet of the main air passage leads to a crankcase of the engine. Typically, a throttle valve is provided in the main air passage to control the amount of fuel and air mixture that enters the crankcase.

Usually, before starting an engine, either a purging system or a priming system is actuated at least once to introduce fresh fuel into the carburetor. Typically, the purging system is used to remove residual air or fuel from the carburetor and fill desired fuel passages and chambers of the carburetor with the fresh fuel, whereas the priming system is used to inject a small quantity of fuel into the air passage. However, such priming system may also be used in addition to performing the functions of a purging system. The fresh fuel supplied to the carburetor before starting the engine facilitates starting of the engine. The purging system and the priming system are typically actuated by a purge bulb and a primer bulb, respectively.

However, after having stored the apparatus after even a very short use, the gasoline component of the two-stroke fuel evaporates and the two-stroke oil component of the fuel is left. This oil can cause sticking and clogging between movable parts, and it may even block small fuel bores. In carburetors having a fuel valve, it may even prevent the fuel valve from opening if closed. However, the oil is easily dissolved when it comes in contact with fresh fuel.

When shutting down the engine many hand held tools set the fuel valve in a closed state. Thereby, fuel leakage through the main and/or idle nozzle is prevented while the tool is stored. If the fuel valve is stuck in this state due to the evaporation of the fuel as described above, it may be difficult or even impossible to start the engine by pulling the cord, since the closed fuel valve blocks any fuel delivery to the main air passage. Even if the fuel valve is partly open the user of the apparatus may have to pull the start cord of the engine repeatedly for a long time until fresh fuel has dissolved the oil residue and the fuel can continue to flow. Many users may experience this as if the apparatus were faulty and will not start at all. Actually, a user may even experience problems when trying to start a brand new product for the first time.

A carburetor of the kind referred to above is disclosed in WO 2009/116902 A1, for example, but does not deal with the sticking/clogging problem.

Further, carburetors of two stroke engines for chainsaws, trimmers and weed cutters and the like apparatus usually have air purging systems. For instance, U.S. Pat. No. 4,271,093 discloses an air purging system and U.S. Pat. No. 6,374,810 B discloses a combined priming and purging system, but they are applied in carburetors of another kind than the one referred to above and do not have a fuel valve with a moveable valve member that may experience sticking/clogging problem.

In addition, when prior art diaphragm carburetors have been equipped with an air purging system, such systems have been connected to a fuel metering chamber in the carburetor. In a diaphragm carburetor having a fuel valve provided downstream of the fuel metering chamber, a connection of the systems to the fuel metering chamber will not accomplish an efficient air purging.

### SUMMARY OF THE INVENTION

A first object of the present invention is to provide a fuel supply system, which reduces the risk of having moveable parts such as a valve member stuck in one position, and that provides good supply of fuel to an engine using the fuel supply system.

In a fuel supply system of the kind referred to in the first paragraph above, this object is achieved with a fuel line connecting said carburetor to said tank and the fuel line being provided with a manually operated purge pump, wherein the fuel line directly connects to the fuel valve or to a fuel conduit between the fuel valve and the nozzles, permitting the purge pump to draw fuel from the inlet through the cavity and optionally returning it to the fuel tank, thereby extracting air possibly present as well as wetting interior surfaces of the cavity with fuel.

To minimize the volume of fuel that has to be drawn off by purging prior to starting the engine, the fuel line section between the purge pump and the fuel cavity or fuel conduit downstream of the outlet port of the valve suitably is of minimum length.

In a fuel supply system of the kind referred to in the first paragraph above, this first main object is also achieved with a fuel line connecting said carburetor to said tank and the fuel line being provided with a manually operated primer pump, wherein the fuel line directly connects to the fuel valve, or to a fuel conduit between the fuel valve and the nozzle, or to the fuel regulator, or to a duct between the fuel regulator and the fuel valve, permitting the primer pump to deliver fuel from the fuel tank to the fuel cavity, either directly, or backwards from the outlet port, or forwardly from the inlet port, thereby wetting interior surfaces of the cavity with fuel.

To ensure that the fuel in the various lines and conduits flows only in the desired direction, it is preferred that a first and a second check valve are provided in the fuel line provided with the purge pump or primer pump, and preferably arranged inside the purge pump or primer pump. Further, it is preferred that a third and a fourth check valve are provided downstream of the outlet port and downstream of the possible connection between the fuel line (with the purge pump or primer pump) and the fuel conduit, such that the fourth check valve is provided in a conduit leading to a main nozzle and the third check valve in a branch conduit leading to at least one idle nozzle.

Another object is to provide a hand held power tool that can easily be started, and which reduces the risk of having moveable parts such as a fuel valve member stuck in one position. This object is achieved by a hand held power tool having the fuel supply system referred to above.

Another object of the invention is to provide a fuel valve suitable for such fuel supply system. In a fuel valve of the kind referred to in the third paragraph above, this objects is achieved in that the fuel valve has a pump port communicated with the fuel cavity, wherein said pump port is intended to be connected to a manually operated pump.

Another object is to provide a carburetor suitable for such fuel supply system. In a carburetor of the kind referred to in the fourth paragraph above, this object is achieved by using a fuel valve of the kind referred to in the third paragraph above that has a pump port communicated with the fuel cavity, wherein said pump port is intended to be connected to a manually operated pump.

Another object is to provide a fuel supply system which provides for less effort and/or less difficulty associated with starting of an internal combustion engine. This object is achieved with the fuel supply system as referred to above for which a fuel line with a purge or primer pump is connected to a fuel conduit or duct or a fuel valve at a position between a metering chamber and a main air passage of a carburetor, i.e. downstream of the metering chamber and upstream of fuel nozzles in the main air passage. Thereby, passageways and/or cavities for communicating the metering chamber with the main air passage or at least interior surfaces thereof will be wetted with fuel upon purging or priming. This implies that fuel needs to travel a shorter distance upon starting of the engine as compared to having the fuel line with the purge pump directly connected to the metering chamber. Consequently, upon starting the engine, smaller effort/difficulty and/or shorter time is required for having fuel entering the engine in case the fuel in said duct/conduit/fuel valve has evaporated. In case the engine is provided with a recoil starter, possibly less start pulls will then be required for starting the engine.

Another object of the present invention is to provide a method for facilitating starting of a carburetor engine, by means of which method fresh fuel is made to flow past and dissolve the oil residue causing sticking and clogging between movable parts and possibly even blocking small fuel bores.

In a method of the kind referred to in the fifth paragraph above, this second main object is achieved by drawing fuel from the inlet port either directly through the cavity or alternatively downstream the fuel outlet port, and returning it to the fuel tank, so as to extract air possibly present as well and to wet interior surfaces of the cavity with fuel.

When alternatively drawing fuel through the fuel conduit, the valve member at start up of the engine preferably being arranged to be offset from the state at least principally blocking fuel flow and/or being adapted to have a leak flow past the valve member when the valve member is in the state at least principally blocking fuel flow.

Preferably, the drawing of fuel is carried out by connecting the fuel cavity to the tank, either directly or indirectly through the fuel conduit, by a fuel line having a purge pump, and operating the purge pump to draw fuel from the inlet through the cavity and return it to the fuel tank, so as to extract air possibly present as well as to wet interior surfaces of the cavity with fuel.

In a method of the kind referred to in the fifth paragraph above, this object is also achieved by delivering fuel from the fuel tank to the fuel cavity either directly, or backwards by injecting fuel downstream the fuel outlet port, or forwardly by injecting fuel upstream the inlet port, so as to wet interior surfaces of the cavity with fuel.

### BRIEF DESCRIPTION OF THE DRAWINGS

In the following, the invention will be described in more detail with reference to preferred embodiments and the appended drawings.

FIG. 1 is a schematic cross sectional view of a two-stroke engine connected to a fuel delivery system.

FIG. 2 is a schematic cross sectional view of the fuel delivery system including a carburetor provided with an air purge/primer system in accordance with an embodiment of the present invention.

FIG. 3 is a schematic cross sectional view of a fuel valve having a port for connecting to the air purge/primer system shown in FIG. 2.

FIG. 4 is a schematic cross sectional view of a fuel valve of FIG. 3 taken along line A-A.

FIG. 5 is a flow scheme of the fuel and air purge systems in accordance with a first embodiment of the present invention.

FIG. 6 is a flow scheme of the fuel and air purge systems in accordance with a second embodiment of the present invention.

FIG. 7 is a flow scheme of the fuel and primer systems in accordance with a third embodiment of the present invention.

FIG. 8 is a flow scheme of the fuel and primer systems in accordance with a fourth embodiment of the present invention.

FIG. 9 is a flow scheme of the fuel and primer systems in accordance with a fifth embodiment of the present invention.

FIG. 10 is a cross sectional view of a purge pump used in FIGS. 5 and 6 or a primer pump used in FIGS. 7, 8 and 9.

FIG. 11 is a schematic cross sectional view of a fuel valve having a port for connection to the primer system shown in FIG. 7.

### MODES FOR CARRYING OUT THE INVENTION

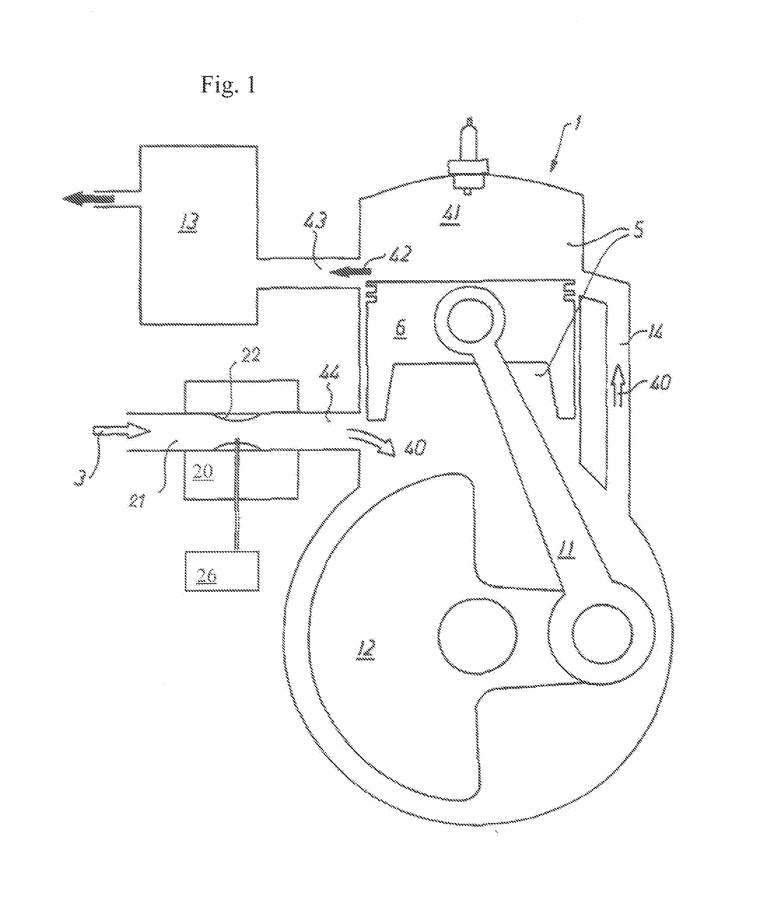

In the schematic FIG. 1, reference numeral 1 designates an internal combustion engine 1 of a two-stroke type. It is crankcase scavenged, i.e. a mixture 40 of air 3 and fuel from a fuel delivery system 20 (e.g. a carburetor or a low pressure fuel injection system) is drawn to the engine crankcase. From the crankcase, the mixture is carried through one or several scavenging passages 14 up to the engine combustion chamber 41. The chamber is provided with a spark plug igniting the compressed air-fuel mixture. Exhausts 42 exit through the exhaust port 43 and through a silencer 13. The engine 1 has a cylinder 5 with a reciprocating piston 6, which by means of a connecting rod 11 is attached to a crankshaft 12 equipped with a counterweight. In this manner the crankshaft is rotated. In FIG. 1, the piston 6 assumes an intermediate position, wherein flow is possible both through an intake port 44, through the scavenging passage 14, and the exhaust port 43. The fuel delivery system 20 has a main air passage 21 for the mixture of air and fuel. The mouth of the main air passage 21 into the cylinder 5 is called intake port 44. Thus, the main air passage 21 is closed by the piston 6. By opening and closing the intake port 44, varying flow speeds and pressures are created inside the main air passage 21. These variations largely affect the amount of fuel supplied when the fuel delivery system 20 is of carburetor type. Since a carburetor has an insignificant fuel feed pressure, the amount of its fuel feed is entirely affected by pressure changes in the main air passage 21. Thus the supplied amounts of fuel are essentially affected by the varying flow speeds and pressures inside the main air passage 21 that are caused by the opening and the closing of the latter. In addition, since the crankcase in crankcase scavenged two stroke engines or crankcase scavenged four stroke engines can hold a considerable amount of fuel and consequently serve as a leveling reservoir, it is not necessary to adjust the fuel delivery for each revolution, i.e. adjusting the fuel delivery in one revolution will affect subsequent revolutions. All these features are entirely conventional in an crank case scavenged internal combustion engine and for this reason they will not be described herein in any closer detail.

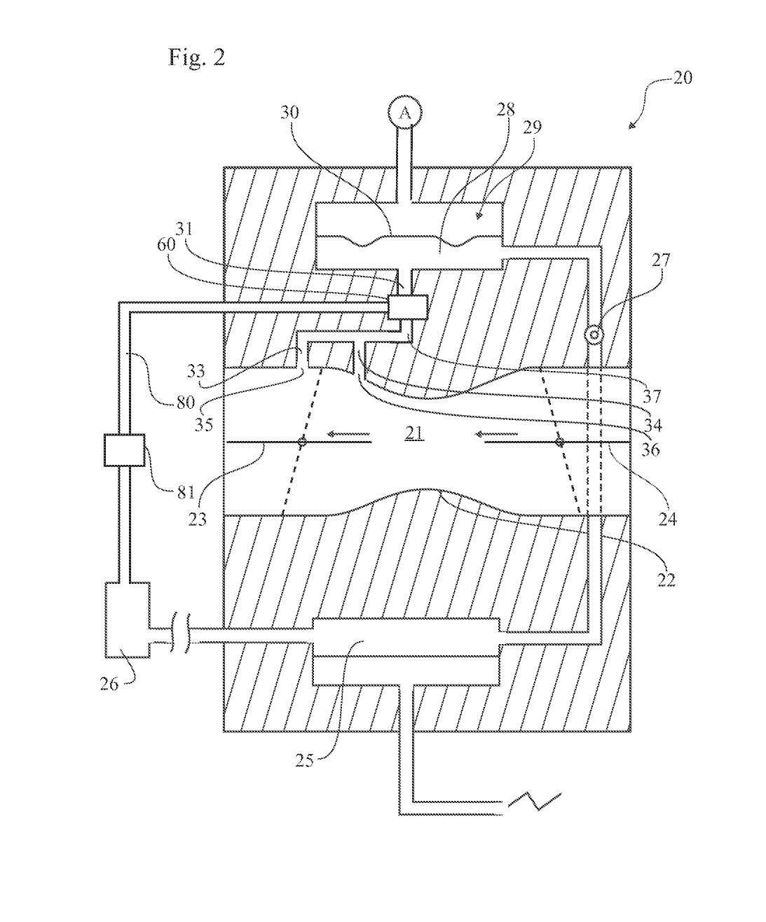

FIG. 2 illustrates a fuel delivery system 20 of carburetor type. The carburetor 20 has an intake passage or main air passage 21 with a constriction 22 giving Venturi effect. A throttle valve 23 and a choke valve 24 are mounted in the main air passage 21. The carburetor further includes a fuel pump 25, which draws fuel from a fuel tank 26.

Preferably, the fuel pump 25 is a pulsation controlled diaphragm pump, driven by the pressure pulses generated by the crankcase of the engine 1. The fuel then passes through a needle or float valve 27 that is controlled by the diaphragm 30 of a fuel regulator 29 and enters a fuel metering chamber 28 of a fuel regulator 29. The fuel metering chamber 28 is separated from atmospheric pressure by the diaphragm 30 and can hold a predetermined amount of fuel. A duct 31, from fuel metering chamber 28, leads to a fuel valve 60. Preferably, the fuel valve 60 is an electrically controlled bistable valve, operating between two states, open and closed. An example of such valve is shown in WO 2009/116902 A1. The fuel valve 60 opens or closes the interconnection between the fuel metering chamber 28 and two fuel lines 33, 34 of different widths leading to the intake passage 21. The narrower channel 33 leads to at least one idle nozzle 35 in the area of the throttle valve 23, at least one nozzle 35 downstream of the throttle valve 23, and the wider channel 34 leads to a main nozzle 36 located upstream the throttle valve 23 and preferably at or downstream the Venturi 22. Due to the varying pressures in the main air passage 21 as the engine operates, fuel is drawn from the fuel metering chamber 28 through the main nozzle 36 and the idle nozzle 35, of course, depending on whether the fuel valve 60 is closed or open. The fuel lines 33, 34 are preferably provided with corresponding check valves 84, 85.

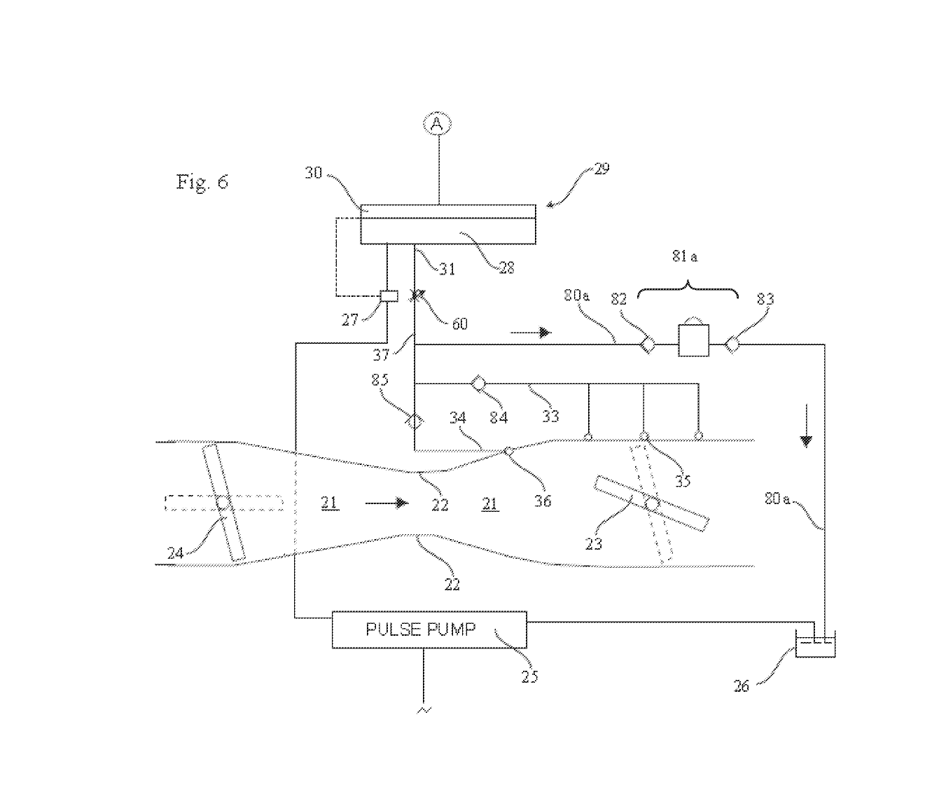

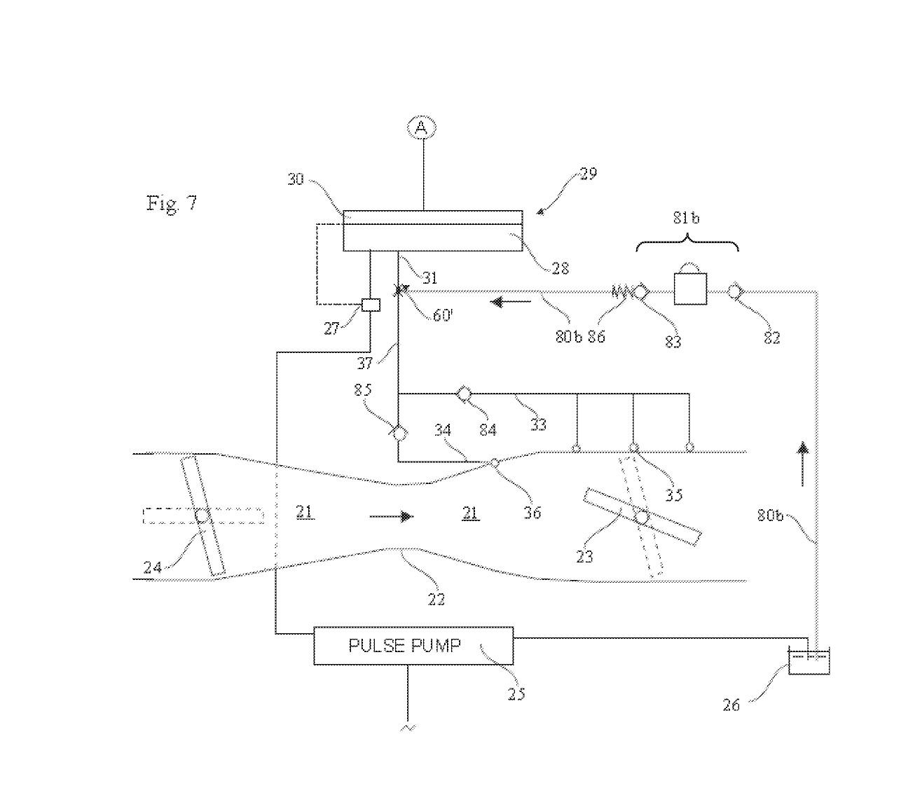

A fuel line generally designated 80 including a manually operated pump generally designated 81 is connected between fuel valve 60 and the fuel tank 26, as also seen in FIGS. 5, and 7. Alternatively the fuel line 80 can connect upstream or downstream the fuel valve 60 as will be described in relation to FIGS. 6, 8 and 9.

In a first and second embodiment shown in FIGS. 5, 6 the pump 81 operates as a purge pump 81a that vents trapped air from the system while wetting the fuel valve 60 with fuel.

And in a third, fourth and fifth embodiment shown in FIGS. 7, 8, 9 the pump 81 operates in the opposite direction, i.e. as a primer pump 81b, supplying fuel to the fuel valve 60.

To provide the desired direction of fuel flow through the purge pump 81a and the primer pump 81b, both of them preferably have two check valves incorporated in the pump design, one 82 upstream and the other 83 downstream of an elastic bulb. However, if desired, both of the check valves 82 and 83 may be provided as separate components. The check valves are not limited to a particular kind of check valve, but could be of many different kinds including ball check valves, duckbill valves etc. Specifically, the check valve may include a weighted body of any suitable form coupled to a resilient member, such as a compression or expansion spring.

The fuel valve 60 is preferably controlled by an electronic control unit, not shown, but described in WO 2009/116902 A1. The control unit receives sensor inputs such as throttle position from at least one throttle positions sensor, not shown, engine speed data from at least one engine speed sensor, not shown, and optionally inputs from additional sensor/s, not shown, e.g. temperature sensor/s. The electronic control unit can use the sensor inputs to control the air to fuel ratio, e.g. decide when to open or close the fuel valve 60.

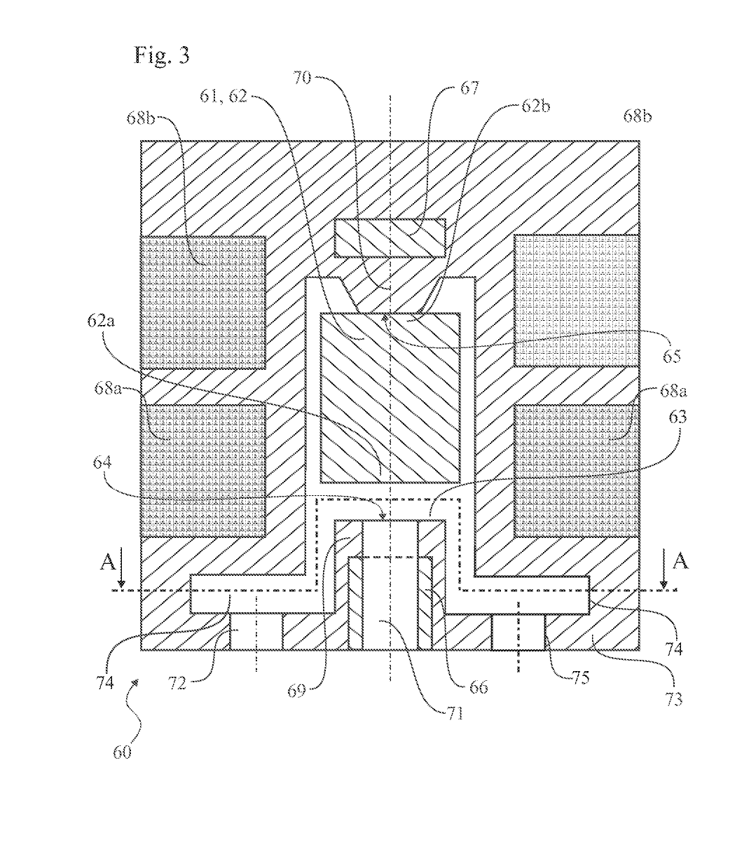

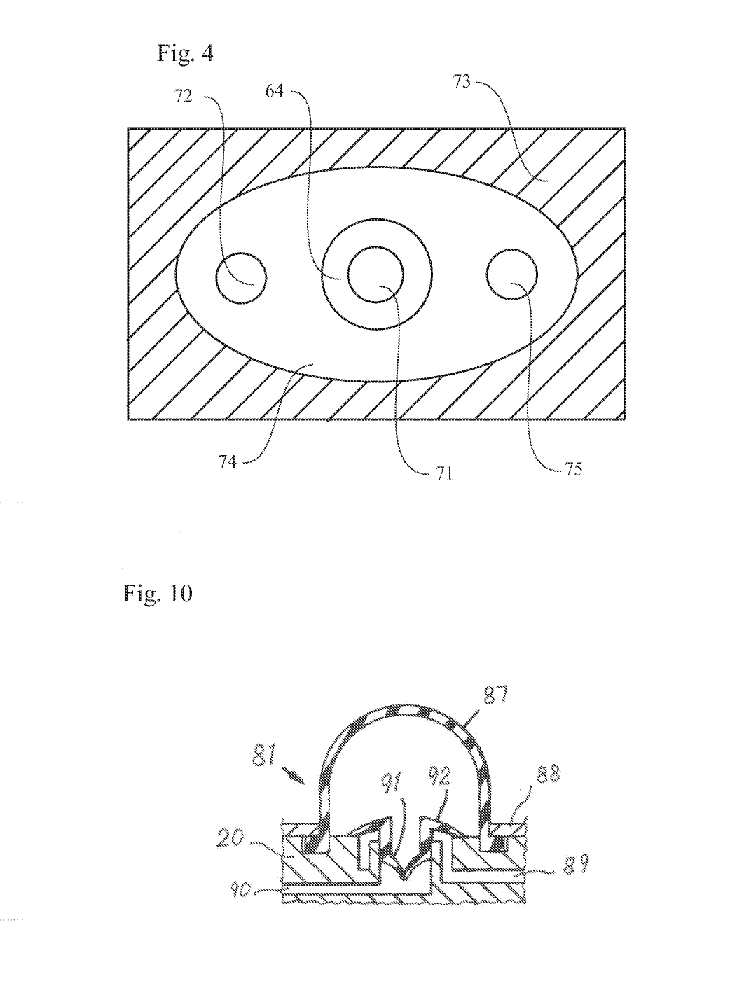

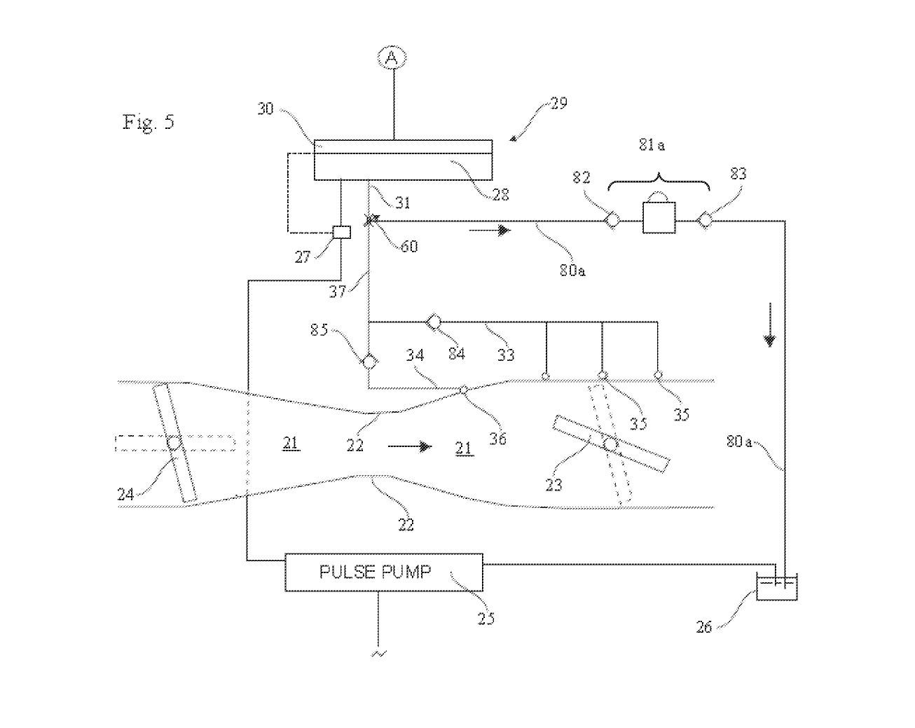

The fuel valve 60 shown in FIGS. 3, 4 includes a valve body 73 with an axially extending generally cylindrical chamber 63, a moveable valve member in the shape of a plunger 61 that is axially moveable in the chamber 63 and includes a permanent magnet 62. Further, the fuel valve 60 includes electromagnetically operating means 68a, 68b for exerting a magnetic force to snap the plunger 61 between a forward and a rearward position (i.e. moving the plunger between an open and a closed state) when energized, and two ferromagnetic elements 66, 67, one at each axial end of the chamber 63.

The axially extending chamber 63 extends in a direction away from the main air passage 21 of the carburetor and has two valve seats 64, 65 that are located opposite each other and limit the axial movement of the plunger 61, namely a front valve seat 64 at a front axial end facing the intake passage 21, and a rear valve seat 65 at the opposite rear axial end. At the front end there are also provided two ports, viz. a first port 71 and second port 72, one of them 72 functioning as an inlet port to the fuel valve and the other 71 as an outlet port from the fuel valve 60. The ports 71, 72 are fluidly connected to one another when the fuel valve 60 is open, forming a cavity-shaped fluid passage 74 between them. If desired, a leak passage, not shown, may be provided to permit a minor leakage of fuel past the valve set 64 when the fuel valve 60 is closed.

The first port 71, preferably the outlet, is a channel of circular cross-section and is located as an opening in the front valve seat 64 and connects through a fuel conduit 37 that branches to form the fuel lines 33 and 34 that lead to the Venturi constriction 22. The front end of the plunger 61 has a cross-section adapted to close the opening of the first port 71.

The second port 72, preferably the inlet, is located beside the front valve seat 64, and connects to the duct 31 from fuel metering chamber 28.

At each valve seat 64, 65 there is a ferromagnetic element 66, 67, viz. a front ferromagnetic element 66 and a rear ferromagnetic element 67, preferably in the form of iron cores. These ferromagnetic elements 66, 67 serve to provide two stable valve states, viz. an open state when the plunger 61 abuts the rear valve seat 65 and a closed state when the plunger 61 abuts the front valve seat 64. At the closed state, the front end of the plunger 61 closes the first port 71 at the front valve seat 64, preventing fluid from flowing between the first 71 and the second port 72, disregarding any possible desired minor leakage if a leak passage, not shown, is provided.

The front ferromagnetic element 66 at least partly surrounds the channel of the first port 71, preferably in a form of an iron tube around the channel, i.e. the front ferromagnetic element 66 preferably provides a section of the channel of the first port 71.

The magnet 62 of the plunger 61 constitutes at least a section of the plunger 61; preferably the entire plunger 61 is a magnet 62. The magnet 62 of the plunger 61 is magnetically oriented in the axial direction, having a front magnetic pole 62a, which faces the front valve seat 64 and interacts with the front ferromagnetic element 66, and a rear magnetic pole 62b that faces the rear valve seat 65 and interacts with the rear ferromagnetic element 67. The magnetic forces between the magnet 62 and the ferromagnetic element 66, 67, respectively, are controlled so that the magnetic force between the front pole 62a and the front ferromagnetic element 66 is stronger than the magnetic force between the rear pole 62b and the rear ferromagnetic element 67, when the plunger 61 abuts the front valve seat 64, and so that the magnetic force between the rear pole 62b and the rear ferromagnetic element 67 is stronger than the magnetic force between the front pole 62a and the front ferromagnetic element 66, when the plunger 61 abuts the rear valve seat 65.

The magnetic forces between the magnet 62 and the ferromagnetic element 66, 67, respectively, are controlled by distancing them from direct contact with one another, by separating them through a front and a rear non-magnetic material 69, 70, respectively, of the front and rear valve seats 64, 65, respectively. The main reason for this is to avoid direct contact between anyone of the ferromagnetic elements 66, 67 and the magnet 62, since the magnetic force between a ferromagnetic element and a magnet grows exponentially the closer they are. Hence, by spacing them apart, the slope of the force curve between them is not as steep as if they were in direct contact, why the tolerances in the production do not need to be as high as if they were not spaced apart. It should be observed, of course, that the spacing apart could be enabled by having a non magnetic material at respectively end of the plunger 61 instead of encapsulating the ferromagnetic element 66, 67 in the valve seats 64, 65. If the distancing insulating material is too thin, there is a risk that it will wear off whereby the magnetic force would increase drastically. Preferably, the distancing material is a polymer having a thickness in the range of 0.3-3 mm, more preferably 0.5-2 mm.

The plunger 61 preferably is cylindrical and has a diameter in the range of 2-12 mm, more preferred 3-8 mm, and preferably it has a length that is larger than its diameter.

The electromagnetically operating means 68a, 68b are provided by two solenoid coils 68a, 68b wound around the axially extending chamber 63 of the valve body 73. The solenoid coils 68a, 68b are wound in opposite winding directions to each other, where a first one 68a of the two solenoids coils 68a, 68b is for snapping the plunger from the rearward position to forward position, and a second one 68b of the two solenoids is for snapping from forward position to rearward position. Of course, it would be possible to have one or more solenoid coils 68a, 68b wound in the same direction, and instead switching the direction of the current to snap the plunger 61 between the two positions. It should be observed that the solenoid coils 68a, 68b do not need to be energized to hold the plunger 61 at anyone of the two stable positions, thus the fuel valve 60 is bistable.

Preferably the fuel valve 60 is arranged to be set in a closed state when the engine is stopped, i.e. a state for which the plunger is resting at the front valve seat 64. This has the advantage of preventing any leakage of fuel from the carburetor when a tool including the carburetor is not in use. However, when attempting to start the engine after a storage period, remaining oil may cause the plunger to get stuck in the closed state and the energy provided by the solenoid coils 68a, 68b when attempting to start may be insufficient to move the plunger 61 to the open state. Furthermore, the suction pressure from the outlet port 71, when pulling the starting cord, will suck the plunger 61 towards the front valve seat 64, not helping to release the plunger 61 from its closed state. This problem can be resolved by wetting the interior of the fuel valve with fuel dissolving any clogging oil. Therefore according to the embodiment shown in FIG. 3, the fuel valve, or more specifically, the valve body 73, is provided with a pump port 75, which is located adjacent the first and second ports 71, 72 at the front end of the valve body 73 and in communication with the second or inlet port 72 through the fuel cavity 74. The pump port 75 is fluidly connected to the second or inlet port 72 regardless of the position of the plunger 61.

In the embodiment shown in FIG. 5, the fuel line 80a is connected to the pump port 75, and the manually operated pump is a purge pump 81a, preferably of the type having an elastic bulb. The upstream check valve 82 is arranged in the fuel line 80a at a position between the pump port 75 and the purge pump 81a, and the downstream check valve 83 is arranged in the fuel line 80a at a position between the purge pump 81a and the fuel tank 26. Upon operation of the purge pump 81a by squeezing the purge bulb, fuel remaining inside the pump is returned through a portion of the fuel line 80a to the fuel tank 26. When releasing the compression, the purge bulb expands creating an internal negative pressure, which draws fuel and possibly air from the inlet port 72 through the cavity 74 and the pump port 75 and into the purge pump 81a. Thereby, fresh fuel flows past and dissolves the possible oil residue that causes sticking and clogging between movable parts and possibly even blocking of small fuel bores. Then, the procedure is repeated once or more times to ensure that no harmful air or oil residue is left inside the fuel valve 60. The pump port 75 is especially useful when the fuel valve 60 being arranged to be normally closed at startup, but also carburetors having fuel valves that are arranged to be partly or fully open at start up can benefit from having a pump port 75 provided in the fuel valve.

In the embodiment shown in FIG. 6, the fuel valve 60 has no pump port 75. Instead, the fuel line 80a is connected to fuel conduit 37 which extends from the outlet port 71 of the fuel cavity 74 towards the nozzles 35, 36 in the main air passage 21 of the carburetor, i.e. at a position downstream the fuel valve 60 but upstream the check valves 84, 85. This embodiment is suitable if the fuel valve 60 is not fully closed at start up, i.e. having the plunger 61 in a position where it does not seal against the valve seat 64, or alternatively, if having a leak passage (not shown) for permitting a minor leakage of fuel between the fuel cavity 74 and the fuel conduit 37 downstream of the valve 60. This embodiment has the advantage that fuel is drawn further downstream, i.e. closer to the main air passage 21, which may reduce the average number of pulls required by a user starting the engine.

The air purging embodiments of FIGS. 5 and 6 may be combined with a priming function as e.g. the one described in U.S. Pat. No. 7,690,342, where at least a part of the fuel drawn through the carburetor due to the purge pressure is supplied directly to the main air passage 21 and/or to the crank case instead of returning it to the tank 26.

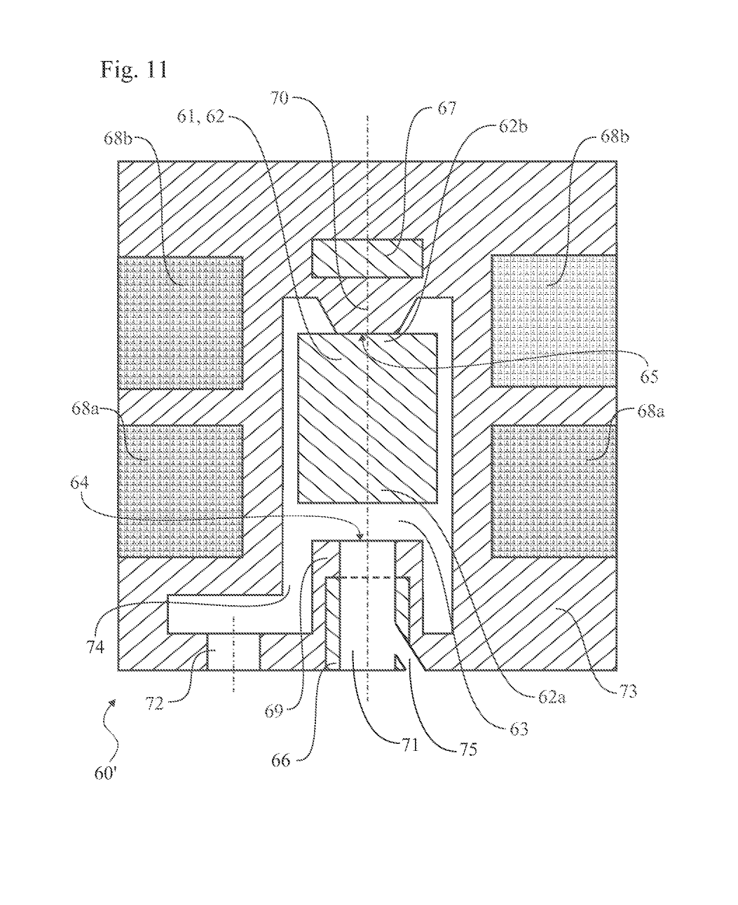

FIG. 7 shows a third embodiment basically similar to the one in FIG. 5, but has a manually operated primer pump 81b, preferably by turning the direction of check valves. i.e. by connecting the downstream check valve 82 towards the fuel tank 26 and the upstream check valve 83 towards the fuel valve 60′. The fuel valve 60′ is preferably of the kind disclosed in FIG. 11, which is similar to the fuel valve designated 60, but differs in that the pump port 75 has been moved from directly communicating with the fuel cavity and instead communicating with a passage of the outlet port 71 provided downstream of the front valve seat 64. By directing the pump port 75 towards the opening at the front valve seat 64 and provided that the fuel pressure applied by the priming operation is large enough, fuel can flow through the valve irrespective of whether it is normally open or closed. Thereby, fresh fuel flows past and dissolves the possible oil residue that causes sticking and clogging between movable parts and possibly even blocking of small fuel bores at the same time as fuel is ejected at least through the main nozzle 36 to provide the desired priming effect. Then, if necessary, the procedure is repeated once or more times to ensure that no harmful air or oil residue is left inside the fuel valve 60. Of course, if the plunger 61 is in a position not closing the fuel valve 60 or there is a leak flow arranged also for the closed state of the fuel valve, fuel can more easily flow through the fuel valve. Since the fuel line 80b here connects to the fuel conduit 37 downstream the fuel valve 60, the upstream check valve 83 may be subjected to significant under pressures from the main air passage 21 when the fuel valve 60 is closed. Therefore, the check valve 83 in this embodiment is preferably of a kind with a spring loaded 86 ball to help keep it shut. However, other kinds of check valves that can resist the under pressure from the main passage 21 could also be used. In an alternative embodiment the primer pump 81b may be connected directly to the fuel cavity 74 by using the fuel valve 60 of FIG. 3. Here the fuel cavity 74 is wetted regardless of if the plunger 61 is in its closed or open state.

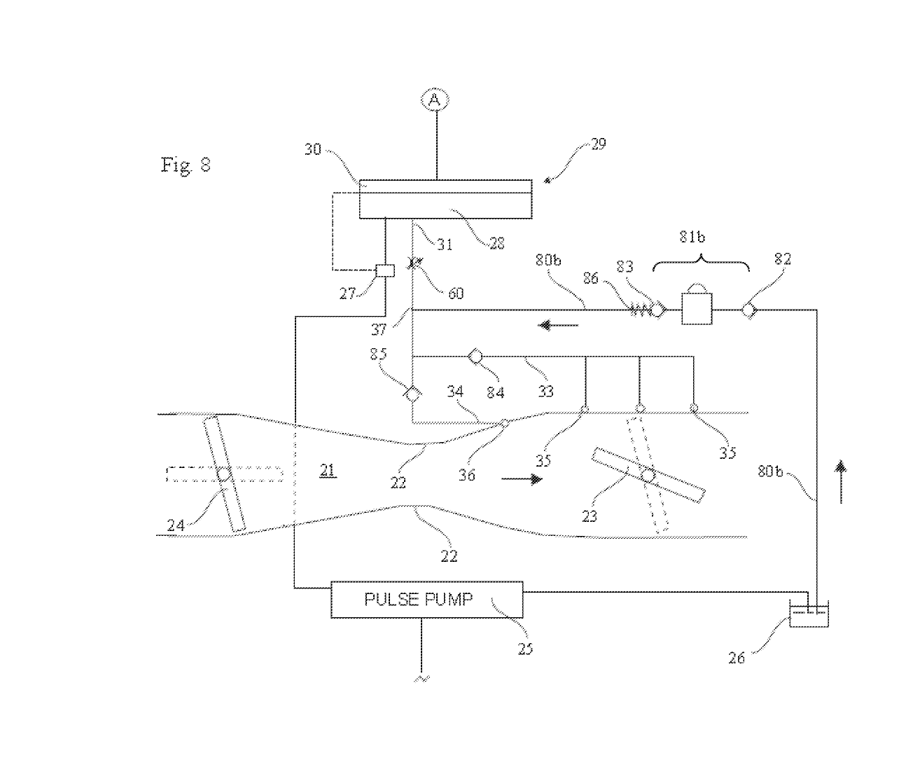

In the embodiment shown in FIG. 8 the fuel valve 60 has no pump port 75. Instead the manually operated primer pump 81b, preferably of the type having an elastic bulb, is connected via the fuel line 80b to the fuel conduit 37 downstream of the fuel valve 60 but upstream the check valves 84, 85. The fuel conduit 37 extends from the outlet port 71 of the fuel cavity 74 towards the nozzles 35, 36 in the main air passage 21 of the carburetor. In this embodiment the primer pump 81b is preferably operated when the plunger 61 is in a position where it does not seal against the valve seat 64, or a leak passage (not shown) is provided for permitting a minor leakage of fuel between the fuel cavity 74 and the fuel conduit 37 downstream of the valve 60. Alternatively or in addition, the restriction caused by the main nozzle 36 is selected to be sufficiently large to create a counter pressure, so that fuel upon operation of the primer pump 81b can flow through the valve irrespective of whether it is normally open or closed, provided that the fuel pressure is large enough. Since the fuel line 80b here connects downstream the fuel valve 60, the upstream check valve 83 may be subjected to significant under pressures from the main air passage 21 when the fuel valve 60 is closed. Therefore, the check valve in this embodiment is preferably of a kind with a spring loaded 86 ball to help keep it shut. However, other kind of check valves that can resist the under pressure from the main passage 21 could also be used.

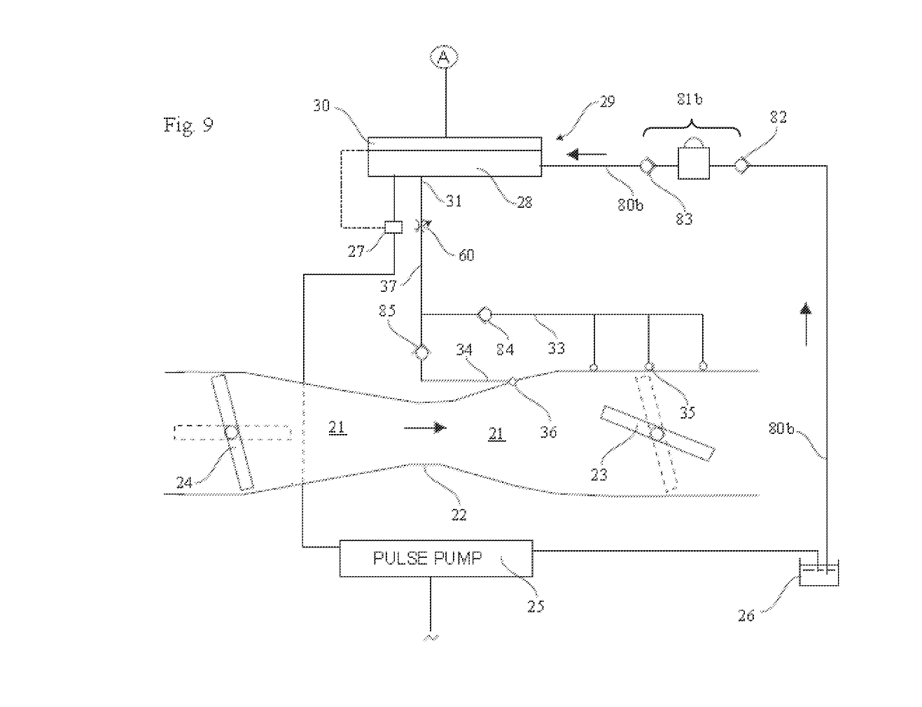

In the embodiment of FIG. 9 the fuel valve 60 has no pump port 75. Instead the manually operated primer pump 81b, preferably of the type having an elastic bulb, is connected via the fuel line 80b to the fuel metering chamber 28 of the fuel regulator 29, i.e. upstream of the fuel valve 60. Alternatively it can be connected to the fuel duct 31. This embodiment functions best if the fuel valve 60 is partly or fully open when starting the engine, since the fuel flow from the primer pump in that case will push trapped air through the fuel valve 60 towards the main and idle nozzles 35, 36.

The embodiments of FIGS. 7-9 may be combined with additional priming functions. E.g. in addition to supplying fuel into the fuel valve 60, fuel can be supplied directly to the main air passage 21 and/or to the crank case.

A simple embodiment of a pump 81 for purging or priming is shown in FIG. 10. The pump 81 includes an elastic bulb 87, which is attached to the carburetor 20, e.g. by the shown mounting arrangement 88. The carburetor 20 has an inlet conduit 89 and an outlet conduit 90, both of which open in the interior space defined by the bulb 87. The opening of the inlet conduit 89 is shown to surround that of the outlet conduit 90, and the latter is comparatively wide to hold a double check valve member. The shown double check valve member has an outlet valve 83 in the shape of a central duckbill valve 91 seated in the opening of the outlet conduit 90 and surrounded by an integral generally annular membrane valve 92 covering the opening of the inlet conduit 89 and forming the inlet check valve 82. When the operator squeezes the bulb 87, fuel will be pressed out between the lips of the duckbill valve 91, and when he releases the bulb 87, the duckbill valve 91 will close and the negative pressure created inside the bulb 87 will open the annular membrane valve 92 and draw fuel through the inlet conduit 89 to fill the bulb 87.

Whereas the invention has been shown and described in connection with the preferred embodiments thereof it will be understood that many modifications, substitutions, and additions may be made which are within the intended broad scope of the following claims. From the foregoing, it can be seen that the present invention accomplishes at least one of the stated objectives.

For instance, even though the fuel valves 60 described above are bistable fuel valves, other fuel valves could be used. For instance the fuel valve could be a mono-stable fuel valve, i.e. where the valve member has only one stable position when not energized. In such case the stable position is preferably a position where the moveable valve member rests against the front valve seat of the fuel valve, i.e. when in the stable position the fuel valve is preferably closed. Furthermore, other means of providing stable positions when not energized than that of magnetic attraction could be used, for instance, a spring urging the moveable valve member toward a certain position. Also fuel valves lacking stable positions when not energized could be used. Furthermore, instead of having an electrically operated fuel valve, the fuel valve could be a mechanically controlled fuel valve.

For instance, the fuel valve 60 could be an integral part of the carburettor or being a separate unit connecting inlet and outlet ports to openings on the carburettor body, i.e. one opening leading to the fuel regulator and another one towards the main and idle nozzles.

For instance, the upstream check valve 82 of the purging pump 81a and the downstream check valve 83 for the purging pump 81b are preferably placed close to where the fuel line 80 connects to the ordinary fuel supply system (e.g. at the connection point at the fuel valve 60, the fuel conduit 37, the duct 31, or the fuel regulator 39 depending on embodiment). Alternatively the fuel line 80 may have additional check valves where the fuel line 80 connects to the ordinary fuel supply system.

### INDUSTRIAL APPLICABILITY

The present invention is especially applicable for use in connection with air purging during the starting of hand-held power-tools such as, but not limited to, chain saws and line trimmers, which as a rule are powered by small two-stroke internal combustion engines that are equipped with diaphragm carburetors.

1. A fuel valve for controlling delivery of fuel to a main air passage of a carburetor of an internal combustion engine, the fuel valve comprising:
at least one inlet port for receiving fuel from a fuel regulator of the carburetor,
at least one fuel outlet port for connecting to at least one nozzle in the air passage leading into the engine,
a fuel cavity between the inlet port and the outlet port, and
a valve member (644 movable in a manner so as to enable at least two states, a first state permitting flow of fuel from the inlet port through the cavity to the outlet port, and a second state at least principally blocking such flow,
wherein the valve has a pump port in communication with the fuel cavity, wherein said pump port is intended to be connected to a manually operated pump.

2. A fuel valve according to claim 1 wherein the pump port is in direct communication with the fuel cavity and communicates the fuel cavity with a purge pump so as to enable drawing of fuel from the inlet port through the cavity and out of the pump port, thereby extracting air possibly present as well as wetting interior surfaces of the cavity.

3. A fuel valve according to claim 1 wherein the pump port is in direct communication with the fuel cavity and communicates the fuel cavity with a primer pump so as to enable injection of fuel into the fuel cavity from a fuel tank, thereby at least wetting interior surfaces of the cavity.

4. A fuel valve as claimed in claim 2, wherein the fuel valve includes an axially extending chamber in which the movable valve member is arranged to move axially between the at least two states, and wherein the ports are located at a front end of the chamber.

5. A fuel valve according to claim 1 wherein the pump port communicates directly with a passage of the fuel outlet port and communicates the outlet port with a primer pump, so as to enable injection of fuel from a fuel tank into the outlet port.

6. A fuel valve according to claim 1, wherein the fuel valve is electrically operated.

7. A fuel valve according to claim 1, wherein the fuel valve is mechanically operated.

8. A fuel valve according to claim 1, wherein at least one of the states is a stable state in the sense that the fuel valve requires to be energized to move the valve member from said stable state.

9. A fuel valve according to claim 1, wherein the fuel valve is an integral part of the carburetor.

10. A fuel valve according to claim 1, wherein the fuel valve is connected to the exterior of the carburetor.

11. A fuel supply system of an internal combustion engine comprising:
a carburetor with a main air passage, the carburetor having a fuel pump supplying fuel to a fuel regulator from a fuel tank, and
a fuel valve including at least one inlet port for receiving fuel from the fuel regulator, and at least one fuel outlet port for connecting to at least one nozzle in the air passage, and a fuel cavity between the inlet port and the outlet port, and a valve member movable in a manner so as to enable at least two states, a first state permitting flow of fuel from the inlet port through the cavity to the outlet port of the valve, and a second state at least principally blocking such flow wherein the fuel supply system further including, either:
a fuel line connecting said carburetor to said tank and having a manually operated purge pump, the fuel line with the purge pump directly communicating with the fuel valve or with a fuel conduit at a position between the fuel valve and the nozzles, so as to permit the purge pump to draw fuel from the inlet through the cavity and optionally returning it to a fuel tank, thereby extracting air possibly present as well as wetting interior surfaces of the cavity with fuel, or
a fuel line connecting said carburetor to said tank and having a manually operated primer pump, the fuel line with the primer pump directly communicating with the fuel valve, or with a fuel conduit at a position between the fuel valve and the nozzle, or to the fuel regulator, or to a duct between the fuel regulator and the fuel valve, so as to permit the primer pump to deliver fuel from the fuel tank to the fuel cavity, either directly, or backwardly from the outlet port, or forwardly from the inlet port, thereby wetting interior surfaces of the cavity with fuel.

12. A fuel supply system according to claim 11 wherein the fuel line is directly connected to the fuel valve via a pump port.

13. A fuel supply system according to claim 11 wherein the fuel line is connected to the fuel conduit, and wherein the valve member at start up of the engine is arranged to be offset from the state at least principally blocking fuel flow or having a leak flow past the valve member when the valve member is in the state at least principally blocking fuel flow.

14. A fuel supply system according to claim 11 wherein a first and a second check valve are provided in the fuel line with the purge or primer pump, wherein the check valves are arranged to allow and direct a fuel flow from the fuel tank towards the carburetor in case of a primer pump, and wherein the check valves are arranged to allow and direct a fuel flow from the carburetor towards the fuel tank in case of a purge pump.

15. A fuel supply system according to claim 11 wherein a third and a fourth check valve are provided downstream of the fuel valve or downstream of the position where the fuel line possibly connects to the fuel conduit, the fourth check valve being provided in a conduit leading to a main nozzle and the third check valve being provided in a branch conduit leading to at least one idle nozzle.

16. A fuel supply system according to claim 10, wherein the fuel supply system is provided in a hand held tool powered by a two stroke crank case scavenged internal combustion engine.

17. A method for facilitating starting of an internal combustion engine including a carburetor with a main air passage the carburetor having a fuel pump supplying fuel to a fuel regulator from a fuel tank, said fuel supply system further including a fuel valve including at least one inlet port for receiving fuel from the fuel regulator, at least one fuel outlet port for connecting to at least one nozzle in the air passage, a fuel cavity between the inlet port and the outlet port, and a valve member movable between at least two states, a first state permitting flow of fuel from the inlet port through the cavity to the outlet port of the valve, and a second state at least principally blocking such flow characterized by drawing fuel from the inlet either directly through the cavity or alternatively downstream the fuel outlet port, and returning it to the fuel tank, so as to extract air possibly present as well as to wet interior surfaces of the cavity with fuel.

18. A method as claimed in claim 17, wherein when alternatively drawing fuel downstream the fuel outlet port, the valve member at start up of the engine being arranged to be offset from the state at least principally blocking fuel flow or being adapted to have a leak flow past the valve member when the valve member is in the state at least principally blocking fuel flow.

19. A method for facilitating starting of an internal combustion engine including a carburetor with a main air passage, the carburetor having a fuel pump supplying fuel to a fuel regulator from a fuel tank, said fuel supply system further including a fuel valve including at least one inlet port for receiving fuel from the fuel regulator, at least one fuel outlet port for connecting to at least one nozzle in the air passage, a fuel cavity between the inlet port and the outlet port, and a valve member movable between at least two states, a first state permitting flow of fuel from the inlet port through the cavity to the outlet port of the valve, and a second state at least principally blocking such flow characterized by delivering fuel from the fuel tank to the fuel cavity either directly, or backwards by injecting fuel downstream the fuel outlet port, or forwardly by injecting fuel upstream the inlet port, so as to wet interior surfaces of the cavity with fuel.
